(19) United States
(12) Patent Application Publication
(10) Pub. No.: US 2024/0055680 A1
(43) Pub. Date: Feb. 15, 2024

(54) METHODS OF RECOVERING LITHIUM FROM A LITHIUM-CONTAINING MATERIAL, AND RELATED SYSTEMS

(71) Applicant: Battelle Energy Alliance, LLC, Idaho Falls, ID (US)

(72) Inventors: Luis A. Diaz Aldana, Idaho Falls, ID (US); Tedd E. Lister, Cotuit, MA (US); Aaron D. Wilson, Idaho Falls, ID (US); John R. Klaehn, Idaho Falls, ID (US); Meng Shi, Idaho Falls, ID (US)

(21) Appl. No.: 18/257,786

(22) PCT Filed: Dec. 15, 2021
(86) PCT No.: PCT/US2021/072937

§ 371 Date: Jun. 15, 2023

Related U.S. Application Data
(60) Provisional application No. 63/126,134, filed on Dec. 16, 2020.

(51) Int. Cl. H01M 10/54; C25B 1/14; C22B 7/00; C25B 9/19; C25B 15/08; C22B 26/12; C22B 3/00

(52) U.S. Cl. CPC H01M 10/54; C25B 1/14; C22B 7/007; C25B 9/19; C25B 15/083; C22B 26/12; C22B 23/0415; H01M 10/0525

(57) ABSTRACT

A method of recovering lithium from a lithium-containing material comprises introducing a lithium-containing material to an electrochemical cell, transporting lithium ions from the lithium-containing material through a cation exchange membrane to a catholyte within a cathode chamber of the electrochemical cell, reacting the lithium ions with bicarbonate ions in the cathode chamber to form lithium carbonate, and removing the lithium carbonate from the catholyte. Related methods of recovering lithium from lithium-containing, materials, and related systems are disclosed.

### CROSS-REFERENCE TO RELATED APPLICATIONS

This application is a national phase entry under 35 U.S.C. § 371 of International Patent Application PCT/US2021/072937, filed Dec. 15, 2021, designating the United States of America and published as International Patent Publication WO 2022/133458 A1 on Jun. 23, 2022, which claims the benefit under Article 8 of the Patent Cooperation Treaty to U.S. Provisional Patent Application Ser. No. 63/126,134, filed Dec. 16, 2020, for “METHODS OF RECOVERING LITHIUM FROM A LITHIUM-CONTAINING MATERIAL, AND RELATED SYSTEMS.” the disclosure of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

Embodiments of the disclosure relate generally to methods of recovering lithium from a lithium-containing material. More particularly, embodiments of the disclosure relate to methods of recovering lithium from a lithium-containing material, such as lithium-ion batteries or a brine solution including lithium, using an electrochemical cell and a switchable polarity solvent, and to related apparatuses for recovering the active materials.

### BACKGROUND

Lithium-ion batteries (LIBs) are one of the most often used rechargeable batteries in consumer electronic devices, such as cellular phones, laptop computers, and video cameras. Lithium-ion batteries are known for their relatively light weight and associated high energy density, low self-discharge rate, high battery voltage, wide operating temperature range, and no memory effect, among other things, making them desirable candidates for use in such electronic devices. In addition to electronic devices, lithium-ion batteries are used in transportation, such as in hybrid and fully electric vehicles (EVs), portable tools, and in various military and aerospace applications. Lithium-ion batteries are also used to store electrical energy for later use within an electrical power grid. Due to the increasing demand for electronic devices and equipment incorporating rechargeable batteries, the global production and consumption of lithium-ion batteries has been rising.

A lithium-ion battery includes an anode, a cathode, electrolytes, a separator between the anode and the cathode, and an outer shell. The separator is made from polymeric materials and the outer shell is conventionally a steel or plastic material. The anode typically includes a composite of carbon powder and a binder (polymer), which is coated with copper foil. The cathode may include an active material comprising lithium cobalt oxide (LiCoO₂), lithium nickel oxide (LiNiO₂) (LNO), lithium manganese oxide (LiMn₂O₄) (LMO), or lithium iron phosphate (FeLiO₄P) (LFP). Other lithium-ion batteries include active materials including other transition metals, such as one or both of nickel and manganese, to partially or completely substitute conventional cobalt to form different types of lithium-including cathode materials. Thus, active cathode materials may include carbon powder, a polymer binder, and lithium transition metal oxides LiCoO₂, LiMn₂O₃, LiNiO₂, LiNiₓCo_{y}Mn_{z}O₂ (LNCM) (LiNi_{1/3}Co_{1/3}Mn_{1/3}O₂), and NiCoAlO.

After lithium-ion batteries reach the end of their useful life (i.e., after the batteries are spent), they are disposed of, such as by sending the batteries to a landfill. However, disposal of the batteries in landfills leads to soil and groundwater contamination due to the presence of various materials present in the batteries. Since the batteries include metals, including cobalt, lithium, nickel, and manganese, various processes have been developed for the separation and subsequent recovery of the metals from spent batteries. Various methods include hydrometallurgical methods or pyrometallurgical methods. Pyrometallurgical methods require smelting the battery materials in a furnace to obtain a metal alloy. However, the smelting process generates and emits harmful gases.

Hydrometallurgical processes include dissolving the cathode materials of the batteries in an acid, such as citric acid, ascorbic acid, hydrochloric acid, sulfuric acid, or nitric acid to form a leachate including the acid and the dissolved metals. The dissolved metals are subsequently recovered from the leachate. However, leaching the metals presents difficulties due to the inherent insolubility of cathode materials (e.g., Co(III)) in such solutions. Therefore, leaching may require significant quantities and strength of acid, which generates significant quantities of waste acid. In addition, some methods of leaching metals in lithium-ion batteries result in hazardous gas emissions (Cl₂, SO₂).

In many operations for the recovery of metals from used lithium-ion batteries, the recovery of metals often focuses on the most valuable metals, such as cobalt. The cost associated with recovery of lithium from the lithium-ion batteries may not be sufficiently offset by the value of the recovered lithium. For example, one method of lithium recovery includes bio-leaching, wherein biodegradable materials are used to recapture the lithium source materials from the waste lithium-ion batteries. However, bio-leaching requires a long incubating period uses acids that require constant addition of make-up acids. Other methods of lithium recovery include precipitation of dissolved lithium, which requires a precipitating agent and typically uses toxic chemical agents to precipitate the lithium.

### BRIEF SUMMARY

Embodiments disclosed herein include methods of recovering lithium from a lithium-containing material, and to related systems. For example, in accordance with one embodiment, a method recovering lithium from a lithium-containing material comprises introducing a lithium-containing material to an electrochemical cell, transporting lithium ions from the lithium-containing material through a cation exchange membrane to a catholyte within a cathode chamber of the electrochemical cell, reacting the lithium ions with bicarbonate ions in the cathode chamber to form lithium carbonate, and removing the lithium carbonate from the catholyte.

Additional embodiments of removing lithium from a lithium-containing material, the method comprising providing a catholyte comprising a protonated switchable polarity solvent in a cathode chamber of an electrochemical cell, transporting lithium ions from a lithium-containing material through a cation exchange membrane into the cathode chamber, reacting the lithium ions with bicarbonate ions to form lithium carbonate in the cathode chamber, reacting the protonated switchable polarity solvent with hydroxide ions to form a deprotonated switchable polarity solvent and water, and contacting the deprotonated switchable polarity solvent with carbon dioxide and water to protonate the deprotonated switchable polarity solvent and produce bicarbonate ions.

In accordance with additional embodiments of the disclosure, a system for recovering lithium from a lithium-containing leachate comprises an electrochemical cell comprising an anode chamber and a cathode chamber, the cathode chamber configured to receive a catholyte comprising a switchable polarity solvent and bicarbonate ions, and a monovalent cation exchange membrane separating the anode chamber from the cathode chamber.

### BRIEF DESCRIPTION OF THE DRAWINGS

FIG. 1 is a simplified schematic of a system for recovering lithium from a lithium-containing material, in accordance with embodiments of the disclosure;

FIG. 2 is a simplified schematic of a system for recovering lithium from a lithium-containing material, in accordance with other embodiments of the disclosure;

FIG. 3 is a simplified schematic of a system 300 for recovering lithium from a lithium-containing material; and

FIG. 4 is a simplified flow diagram illustrating a method of recovering lithium from a lithium-containing material, in accordance with embodiments of the disclosure.

### DETAILED DESCRIPTION

Illustrations presented herein are not meant to be actual views of any particular material, component, or system, but are merely idealized representations that are employed to describe embodiments of the disclosure.

The following description provides specific details, such as material types, dimensions, and processing conditions in order to provide a thorough description of embodiments of the disclosure. However, a person of ordinary skill in the art will understand that the embodiments of the disclosure may be practiced without employing these specific details. Indeed, the embodiments of the disclosure may be practiced in conjunction with conventional fabrication techniques employed in the industry. In addition, the description provided below does not form a complete process flow, apparatus, or system for recovering metals from a lithium-containing material, such as a lithium-ion battery. Only those process acts and structures necessary to understand the embodiments of the disclosure are described in detail below. Additional acts to recover lithium from a lithium-containing material may be performed by conventional techniques. Also note, any drawings accompanying the present application are for illustrative purposes only, and are thus not drawn to scale. Additionally, elements common between figures may retain the same numerical designation.

According to embodiments described herein, a method of recovering lithium from a lithium-containing material (e.g., a leachate including dissolved lithium (e.g., such as a leachate used to dissolve metals of a lithium-ion battery), a brine including dissolved lithium) includes introducing the lithium-containing material to an electrochemical cell. The lithium-containing material may include a leachate from a leaching process of leaching electrode materials of a lithium-ion battery, a brine solution, or another material including lithium.

In some embodiments, the electrochemical cell includes a center chamber separated from an anode chamber comprising an anode by a first membrane. The center chamber is separated from a cathode chamber comprising a cathode by a second membrane comprising a cation exchange membrane, such as a monovalent cation exchange membrane. The second membrane may be substantially selective to lithium cations (also referred to herein as “lithium ions”) and may, for example, facilitate selective transport of the lithium ions from the center chamber to the cathode chamber. The first membrane (e.g., a bipolar membrane) may facilitate a water splitting reaction (e.g., hydrolysis) to generate hydroxide ions and hydrogen ions and transport of hydroxide ions to the anode chamber and hydrogen ions to the center chamber. Hydroxide ions may react at the anode to generate water, oxygen, and electrons. In some embodiments, the lithium-containing material is introduced into the center chamber. In other embodiments, the electrochemical cell does not include the center chamber and includes only a cathode chamber separated from an anode chamber by a cation exchange membrane selective to lithium cations. In some such embodiments, the lithium-containing material is introduced into the anode chamber.

The lithium ions may be transported from the center chamber through the second membrane and to the cathode chamber. In other embodiments, such as where the electrochemical cell does not include the center chamber, the lithium ions may be transported from the anode chamber to the cathode chamber through the cation exchange membrane. The cathode chamber may include a catholyte comprising a switchable polarity solvent (e.g., one or more amines, such as one or more tertiary amines (e.g., methyldiethanolamine)) and bicarbonate ions. In some embodiments, the switchable polarity solvent may be formulated and configured to reversibly switch from a lower polarity state (e.g., a nonpolar state that is soluble in an organic phase) to a higher polarity state (e.g., a polar state that is soluble in an aqueous phase) responsive to protonation and deprotonation thereof. Stated another way, the switchable polarity solvent may be configured to switch between an aqueous phase and an organic phase depending on whether the switchable polarity solvent is protonated or deprotonated, respectively. The lithium ions transferred to the catholyte may react with the bicarbonate ions and hydroxide ions to form lithium carbonate, which may be insoluble in the catholyte. The reaction may also generate water. In addition, the switchable polarity solvent may also react with hydroxide ions in the cathode chamber to form water and deprotonate the switchable polarity solvent. In some embodiments, the deprotonated switchable polarity solvent may be soluble in an organic phase. The catholyte may be circulated from the cathode chamber and passed through a filter to remove the lithium carbonate from the catholyte and to thereby separate and recover the lithium from the catholyte. After removing the lithium carbonate, the catholyte may be contacted with carbon dioxide to react the deprotonated switchable polarity solvent and water with the carbon dioxide and form bicarbonate ions and protonate the switchable polarity solvent. The protonated switchable polarity solvent may be soluble in an aqueous phase. Contacting the catholyte with the carbon dioxide may regenerate the switchable polarity solvent and provide carbonate ions, which may be circulated back to the cathode chamber. The protonated switchable polarity solvent and the bicarbonate ions may react with hydroxide ions and lithium ions, respectively, and the process may be repeated. Accordingly, lithium ions from the catholyte may be converted to lithium carbonate without excessive chemical consumption and in a continuous process. The bicarbonate ions may be generated from interaction of the switchable polarity solvent with carbon dioxide. Accordingly, the bicarbonate ions may be provided by a renewable source that is readily available.

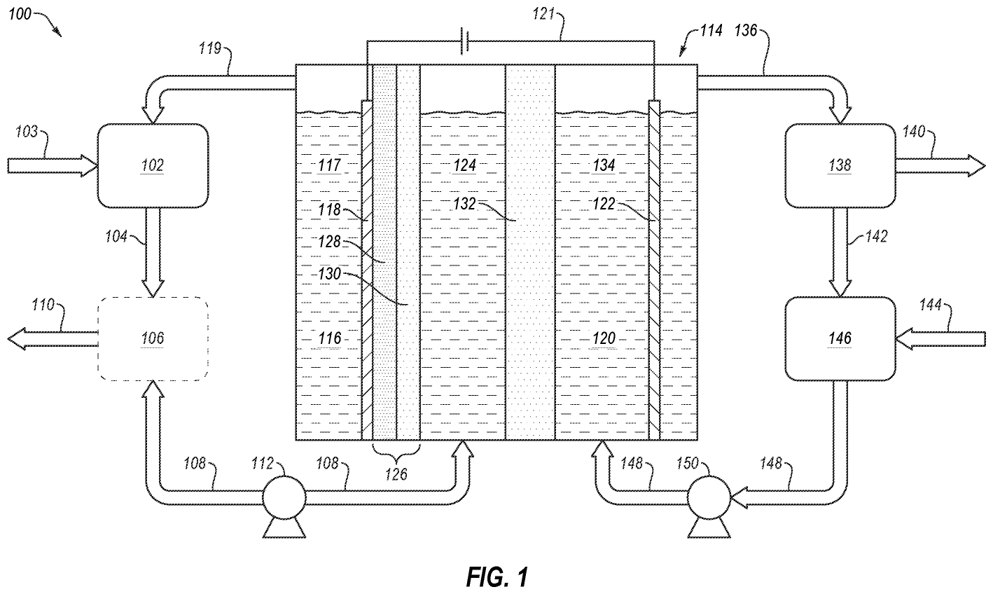

FIG. 1 is a simplified schematic of a system 100 for recovering lithium from a lithium-containing material, in accordance with embodiments of the disclosure. For example, in some embodiments, a first vessel 102 may include a leachate solution 104 including one or more dissolved metals therein. The leachate solution 104 may be provided from a leachate feed solution 103. In some embodiments, the leachate feed solution 103 is non-continuously provided (e.g., in a batch wise manner) to the first vessel 102. In other embodiments, the leachate feed solution 103 is substantially continuously provided to the first vessel 102.

The leachate feed solution 103 and the leachate solution 104 may include, for example, an acid and one or more dissolved metals. By way of non-limiting example, the acid may include one or more of hydrochloric acid, sulfuric acid, nitric acid, phosphoric acid, gluconic acid, or another acid. In some embodiments, the acid includes hydrochloric acid. The leachate solution 104 may comprise a leachate solution from the extraction of one or more metals from, for example, lithium-ion batteries (LIBs). However, the disclosure is not so limited and the leachate solution 104 may be from other materials including lithium and not be associated with leaching of metals from lithium-ion batteries.

The one or more metals of the leachate solution 104 may include one or more of lithium, nickel, cobalt, manganese, aluminum, iron, or another metal. In some embodiments, the leachate solution 104 comprises lithium, nickel, cobalt, and manganese. In some embodiments, the leachate solution 104 comprises lithium and other dissolved metals may have previously been removed from the leachate solution 104.

With continued reference to FIG. 1, in some embodiments, one or more metals may be removed (e.g., selectively removed) from the leachate solution 104 in an optional metal extraction process 106. FIG. 1 illustrates the metal extraction process 106 in dashed lines since, in some embodiments, the system 100 may not include the metal extraction process 106. In some embodiments, the metal extraction process 106 may include selectively removing one or more metals from the leachate solution 104 to form a solution 108 including dissolved lithium and a metal-containing material 110.

The metal extraction process 106 may be configured to selectively separate one or more metals (e.g., target metals) relative to lithium from the leachate solution 104 to form the solution 108 including lithium and the metal-containing material 110. The metal extraction process 106 may include one or more of a liquid-liquid extraction cell (e.g., a solvent extraction cell) and one or more separation vessels. By way of non-limiting example, the metal extraction process 106 may facilitate separation of cobalt and manganese from lithium and nickel to form a metal-containing material 110 (e.g., a metal-containing solution) comprising cobalt and manganese and a solution 108 including lithium and nickel by means of solvent extraction, as described in International Application No. PCT/US2020/070081, published as WO 2020/252495 A1, the entire disclosure of which is incorporated herein in its entirety by this reference. In yet other embodiments, the metal extraction process 106 is configured to separate nickel and cobalt from the leachate solution 104 to form a metal-containing material 110 comprising the nickel and cobalt and a solution 108 including lithium and, optionally, manganese.

In some embodiments, a pump 112 may be configured to circulate the solution 108 from the metal extraction process 106 to an electrochemical cell 114. The electrochemical cell 114 may be configured to selectively separate lithium ions from the solution 108.

The electrochemical cell 114 may include an anode chamber 116 including an anode 118, a cathode chamber 120 including a cathode 122, and a center chamber 124 between the anode chamber 116 and the cathode chamber 120. The solution 108 may be provided to the center chamber 124. A first membrane 126 may separate the center chamber 124 from the anode chamber 116. A second membrane 132 may separate the center chamber 124 from the cathode chamber 120. Although the electrochemical cell 114 has been described and illustrated as including the center chamber 124, the disclosure is not so limited. As will be described herein, the electrochemical cell 114 may not include the center chamber 124 and the anode chamber 116 may not be separated from the cathode chamber 120 by the center chamber 124.

The first membrane 126 may comprise a bipolar membrane formulated and configured to allow transport (e.g., passage) of hydroxide ions (OH⁻) therefrom while substantially electrically insulating the anode chamber 116 from the center chamber 124. In some embodiments, the first membrane 126 is substantially impermeable to lithium ions. In some embodiments, the first membrane 126 is further substantially impermeable to monovalent ions (e.g., lithium ions) and other metal cations such as ions of one or more of cobalt, manganese, nickel, aluminum, copper, or another metal. In other embodiments, the first membrane 126 is substantially impermeable to monovalent ions and permeable to other metal cations such as ions of one or more of cobalt, manganese, nickel, aluminum, or copper. In some embodiments, the first membrane 126 comprises an anion exchange layer 128 on the side of the anode chamber 116 and a cation exchange layer 130 on the side of the center chamber 124.

The first membrane 126 may be configured to facilitate the splitting of water to generate hydroxide ions and hydrogen ions due to the voltage difference between the anode 118 and the cathode 122 of the electrochemical cell 114. The hydroxide ions are transferred to the anode chamber 116 and to the anode 118 through the anion exchange layer 128. In addition, hydrogen ions (e.g., protons) may be transferred to the center chamber 124 through the cation exchange layer 130. In some embodiments, the anode 118 may facilitate the reaction of the hydroxide ions to form water, according to equation (1) below:

2OH⁻→½O₂+H₂O+2e⁻; (1).

The reaction at the anode 118 generates electrons that may facilitate operation of the electrochemical cell 114, as will be described herein. In some embodiments, the anode chamber 116 comprises an anolyte 117 comprising, for example, hydroxide ions and one or more metal cations (e.g., one or more of manganese ions, nickel ions, and cobalt ions).

In some embodiments, such as where the solution 108 includes one or more metals in addition to lithium (such as one or more of dissolved manganese, nickel, and cobalt), the one or more metals may be deposited on the surface of the anode 118 during use and operation of the system 100. For example, at the anode 118, manganese may be oxidized to form manganese oxide, according to equation (2) below:

Mn²⁺+2H₂O→MnO₂(s)+4H⁺+2e⁻; (2).

The anode 118 may include one or more suitable materials for facilitating the reaction at the anode 118. For example, the anode 118 may comprise a material suitable for conducting electricity and exhibiting a tolerance to aqueous solutions (e.g., water, hydroxide ions, etc.). By way of non-limiting example, the anode 118 may include one or more of carbon (e.g., graphite, such as graphite foil), platinum, nickel, stainless steel, titanium, and iridium oxide. In some embodiments, the anode 118 comprises a coating of iridium oxide on titanium. In other embodiments, the anode 118 comprises a coating of iridium oxide on platinum. However, the disclosure is not so limited and the anode 118 may comprise one or more materials other than, or in addition to, those described.

In some embodiments, the anolyte 117 is recycled from the anode chamber 116 to the first vessel 102 in an anolyte recycle stream 119. In some embodiments, at least a portion of the anolyte 117 is purged from the anode chamber 116.

The center chamber 124 may include the solution 108, including dissolved metal ions therein. In some embodiments, the solution 108 may include one or more components of one or more acids used to leach the one or more metals from a material (e.g., from a lithium-ion battery). By way of non-limiting example, the solution 108 in the center chamber 124 may include chloride ions.

The second membrane 132 may physically separate the center chamber 124 from the cathode chamber 120. The second membrane 132 may be formulated and configured to facilitate selective transport of one or more metal cations from the center chamber 124 to the cathode chamber 120. The second membrane 132 may comprise a cation exchange membrane (CEM). In some embodiments, the second membrane 132 comprises a monovalent cation exchange membrane configured to facilitate selective transfer of monovalent cations from the center chamber 124 to the cathode chamber 120. In some embodiments, the second membrane 132 is configured to facilitate selective transfer of lithium cations from the center chamber 124 to the cathode chamber 120. By way of non-limiting example, the second membrane 132 may comprise a lithiated perfluorinated sulfonic acid (PF SA-Li) ion exchange membrane, cation exchange membranes including lithium-ion sieves in a sulfonated poly(ether ether ketone) matrix, or another type of monovalent cation exchange membrane. In some embodiments, the second membrane 132 comprises a SELEMION™ CSO membrane commercially available from AGC Engineering Co., Ltd. of Chiba, Japan.

The cathode 122 may be formed of and include one or more suitable materials for facilitating the reactions at the cathode chamber 120 and the cathode 122. The cathode 122 may include, for example, one or more of platinum, nickel (e.g., a nickel mesh), a gold plated material, iridium oxide, titanium, or carbon (e.g., graphite, such as graphite foil). In some embodiments, the cathode 122 comprises a coating of iridium oxide on titanium. In other embodiments, the cathode 122 comprises a coating of iridium oxide on platinum. However, the disclosure is not so limited and the cathode 122 may comprise one or more materials other than, or in addition to, those described.

With continued reference to FIG. 1, the cathode chamber 120 may include a catholyte 134. The catholyte 134 may include cations (e.g., lithium) that are transferred from the center chamber 124 to the cathode chamber 120. In addition, the catholyte 134 may include a switchable polarity solvent (SPS) formulated and configured to switch polarity upon contact with a chemical agent, which may facilitate separation of the cations in the catholyte from other components thereof, as will be described herein.

The switchable polarity solvent of the catholyte 134 in the cathode chamber 120 may include an amine (e.g., one or more of a primary amine, a secondary amine, and a tertiary amine), guanidine, a mixture of 2-n-butyl-1,1,3,3-tetramethylguanidine and ethylene glycol, 1,8-diazabicyclo-[5.4.0]-undec-7-ene (DBU) (C₉H₁₆N₂) (also referred to as diazabicycloundecene) (which may be mixed with an alcohol, such as 1-propanol), 1-cyclohexylpiperidine (CHP), or another material. Non-limiting examples of amines that may be used as the switchable polarity solvent include one or more of methyl diethanolamine (MDEA), diethanolamine (DEA), monoethanolamine (MEA), diisopropanolamine (DIPA), aminoethoxyethanol (diglycolamine) (DGA), N,N-dimethyl-n-alkylamine, 2-ethylehexylamine, N,N-benzyl methylamine, dibutylamine, and dimethylcyclohexylamine (DMCA), N-methylcyclohexylamine (MCA), and di-sec-butylamine (DSBA). In some embodiments, the switchable polarity solvent comprises a tertiary amine, such as methyl diethanolamine. In some embodiments, the switchable polarity solvent comprises one or more tertiary amines and one or both of one or more primary amines and one or more secondary amines to facilitate the capture of carbon dioxide. By way of non-limiting example, in some embodiments, the switchable polarity solvent comprises dimethylcyclohexylamine combined with one or both of N-methylcyclohexylamine and di-sec-butylamine.

In some embodiments, the catholyte 134 comprises a two-phase system including an organic phase and an aqueous phase. In some embodiments, the aqueous phase comprises water and the organic phase comprises a material that is substantially insoluble in water, such as an insoluble alcohol (e.g., one or more of butanol, pentanol, hexanol, and heptanol). In some such embodiments, the catholyte 134 comprises the switchable polarity solvent dispersed in another liquid such as, for example, one or more of water, an alcohol (e.g., one or more of butanol, pentanol, hexanol, and heptanol), or both. In some embodiments, the catholyte 134 comprises the switchable polarity solvent dispersed in a mixture comprising water and one or more alcohols. In some embodiments, the one or more alcohols are substantially insoluble in water.

As will be described herein, in use and operation, the switchable polarity solvent may be protonated and deprotonated to switch a polarity of the switchable polarity solvent and to facilitate recovery of the lithium from the catholyte 134. For example, in some embodiments, when the switchable polarity solvent is protonated, the switchable polarity solvent may be soluble in an aqueous phase (e.g., the water of the catholyte 134) and when the switchable polarity solvent is deprotonated, the switchable polarity solvent may be soluble in an organic phase (e.g., the alcohol of the catholyte 134). In some embodiments, the switchable polarity solvent may remain at least partially soluble in the aqueous phase after deprotonation thereof. The protonation and deprotonation of the switchable polarity solvent may facilitate provision of a material configured to react with (e.g., form a precipitate of) the lithium ions in the catholyte 134. For example, in the cathode chamber 120, bicarbonate (HCO₃⁻) ions may react with the lithium cations and hydroxide ions to form lithium carbonate, according to equation (3) below:

2Li⁺+HCO₃⁻+OH⁻→Li₂CO₃(s)+H₂O; (3).

The lithium carbonate may comprise a solid and precipitate in the catholyte 134, facilitating separation of the lithium carbonate from the catholyte 134. Accordingly, in some embodiments, the lithium from the catholyte 134 may be removed from the catholyte 134 by reaction with bicarbonate ions and hydroxide ions to form water and insoluble lithium carbonate.

In addition to reaction (2) above, additional reactions may occur within the cathode chamber 120. For example, water in the catholyte may be reduced by the electrons from the anode 118 to generate hydrogen gas and hydroxide ions, according to equation (4) below.

2H₂O+2e⁻→H₂(g)+2OH⁻; (4).

In the cathode chamber 120, the protonated switchable polarity solvent (represented as SPSH⁺) reacts with hydroxide ions in the cathode chamber to deprotonate the switchable polarity solvent (represented as SPS) and water, according to equation (5) below.

SPSH⁺(aq)+OH⁻→SPS(org)+H₂O; (5).

Accordingly, the overall reaction at the cathode side (e.g., the cathode chamber 120 and in the circuit including the switchable polarity solvent) proceeds according to equation (6) below:

2Li⁺+CO₂+H₂O+2e⁻→Li₂CO₃(s)+H₂(g); (6).

In some embodiments, the deprotonation of the protonated switchable polarity solvent to form the deprotonated switchable polarity solvent (SPS) may change the polarity of the switchable polarity solvent such that the switchable polarity solvent is soluble in a different phase. For example, the deprotonated switchable polarity solvent may be soluble in an organic phase (e.g., in an alcohol) while the protonated switchable polarity solvent is soluble in an aqueous phase (e.g., in water). In equation (5) above, SPS (org) refers to the deprotonated switchable polarity solvent that is soluble in the organic phase (as opposed to the aqueous phase). However, the disclosure is not so limited and the deprotonation and protonation of the switchable polarity solvent may not change the phase in which the switchable polarity solvent is soluble. For example, in some embodiments, the protonated and deprotonated switchable polarity solvent may be soluble in the aqueous phase.

In use and operation, a current may be applied between the anode 118 and the cathode 122. By way of non-limiting example, the electrochemical cell 114 may be operated at a current density within a range from about 10 A/cm² to about 100 A/cm², such as from about 10 A/cm² to about 20 A/cm², from about 20 A/cm² to about 40 A/cm², from about 40 A/cm² to about 60 A/cm², from about 60 A/cm² to about 80 A/cm², or from about 80 A/cm² to about 100 A/cm². However, the disclosure is not so limited and the current density may be different than those described.

In some embodiments, a potential may be applied between the anode 118 and the cathode 122, as indicated at 121.

With continued reference to FIG. 1, the catholyte 134 from the cathode chamber 120 may be circulated out of the cathode chamber 120 as a lithium carbonate-containing catholyte 136. The lithium carbonate-containing catholyte 136 may include lithium carbonate, the deprotonated switchable polarity solvent, water, and hydrogen gas. In some embodiments, the lithium carbonate-containing catholyte 136 may be passed through a filter 138 configured to separate the lithium carbonate from the lithium carbonate-containing catholyte 136 and form a lithium carbonate material 140 (e.g., solid lithium carbonate) and a deprotonated switchable polarity solvent catholyte 142.

In some embodiments, a purity of the lithium carbonate material 140 may be greater than about 90 atomic percent, greater than about 95 atomic percent, greater than about 98 atomic percent, or even greater than about 99 atomic percent.

The deprotonated switchable polarity solvent catholyte 142 may come into contact with a carbon dioxide-containing material 144 in, for example, a vessel 146. The vessel 146 may comprise, for example, a bubbler configured to flow the carbon dioxide-containing material 144. The carbon dioxide-containing material 144 may comprise, for example, commercially pure carbon dioxide, an exhaust stream containing carbon dioxide (e.g., a refinery exhaust stream, a stream associated with production of cement, a stream associated with the production of line, a stream associated with the production of iron and steel, exhaust from coal-fired or natural gas power plants), or another source of carbon dioxide.

A purity of the carbon dioxide in the carbon dioxide-containing material may be within a range from about 20 atomic percent to about 100 atomic percent, such as from about 20 atomic percent to about 40 atomic percent, from about 40 atomic percent to about 60 atomic percent, from about 60 atomic percent to about 80 atomic percent, from about 80 atomic percent to about 90 atomic percent, or from about 90 atomic percent to about 100 atomic percent. However, the disclosure is not so limited and the purity of the carbon dioxide in the carbon dioxide-containing material 144 may be different than that described.

The carbon dioxide from the carbon dioxide-containing material 144 may react with the deprotonated switchable polarity solvent of the lithium carbonate-containing catholyte 136, and the water of the deprotonated switchable polarity solvent catholyte 142 to protonate the switchable polarity solvent and form a recycle catholyte 148 comprising the protonated switchable polarity solvent and bicarbonate, according to equation (7) below:

SPS(org)+CO₂(g)+H₂O→SPSH⁺(aq)+HCO₃⁻; (7).

The polarity of the deprotonated switchable polarity solvent in the deprotonated switchable polarity solvent catholyte 142 may change from nonpolar state to a polar state responsive to protonation of the deprotonated switchable polarity solvent.

The recycle catholyte 148 may provide protonated switchable polarity solvent and bicarbonate to the cathode chamber 120, which may facilitate capture of the dissolved lithium, as described above with reference to equation (3) and equation (4). A pump 150 may be configured to circulate the recycle catholyte 148 from the vessel 146 to the cathode chamber 120. The overall reaction for the capture of the lithium from the catholyte 134 may be represented according to equation (8) below:

2Li⁺+CO₂(g)+2H₂O→Li₂CO₃(s)+½O₂(g)+H₂(g)+2H⁺; (8).

The catholyte 134 may be maintained at a temperature within a range from about 50° C. to about 70° C., such as from about 50° C. to about 60° C., or from about 60° C. to about 70° C. However, the disclosure is not so limited and the temperature of the catholyte 134 may be different than those described. In some embodiments, the lithium carbonate may precipitate and be removed from the catholyte 134 at lower temperatures than conventional processes for recovery of lithium, which often require temperatures greater than about 90° C.

Accordingly, the carbon dioxide from the carbon dioxide-containing material 144 may be used to facilitate capture of the lithium in the catholyte 134. Since carbon dioxide is a readily available material, the lithium may be captured at a relatively low cost compared to conventional methods of recovering lithium from a solution including dissolved lithium. In addition, the switchable polarity solvent may facilitate generation of bicarbonate from the carbon dioxide, which facilitates formation of the lithium carbonate. Reaction of the deprotonated switchable polarity solvent with water and carbon dioxide may protonate the switchable polarity solvent and regenerate the switchable polarity solvent for reuse in the cathode chamber 120. Stated another way, the switchable polarity solvent acts as a mediator for facilitating the reaction of carbon dioxide to form the lithium carbonate. The use of the switchable polarity solvent may facilitate removal of the lithium from the catholyte 134 without consumption of acids or other chemical reagents as in conventional methods of recovering lithium. Rather, the switchable polarity solvent facilitates capture of the lithium with renewable carbon dioxide. In addition, the use of renewable carbon dioxide to generate the bicarbonate used for reacting with the lithium may reduce the overall cost associated with the recovery of lithium. As such, the disclosed method may facilitate recovery of lithium from lithium-ion battery electrodes that do not include high-value materials, such as cobalt and nickel. For example, the disclosed method may facilitate recovery of lithium from electrode materials comprising, for example, lithium iron phosphate (FeLiO₄P) (LFP).

Although FIG. 1 has been described and illustrated as recovering lithium from a leachate solution 104 from the extraction of one or more metals, such as from lithium-ion batteries, the disclosure is not so limited. In other embodiments, the system 100 may be configured to recover lithium from other lithium-containing materials. For example, in some embodiments, the system 100 may facilitate recovery of lithium from a brine including lithium and one or more other dissolved metals, such as magnesium.

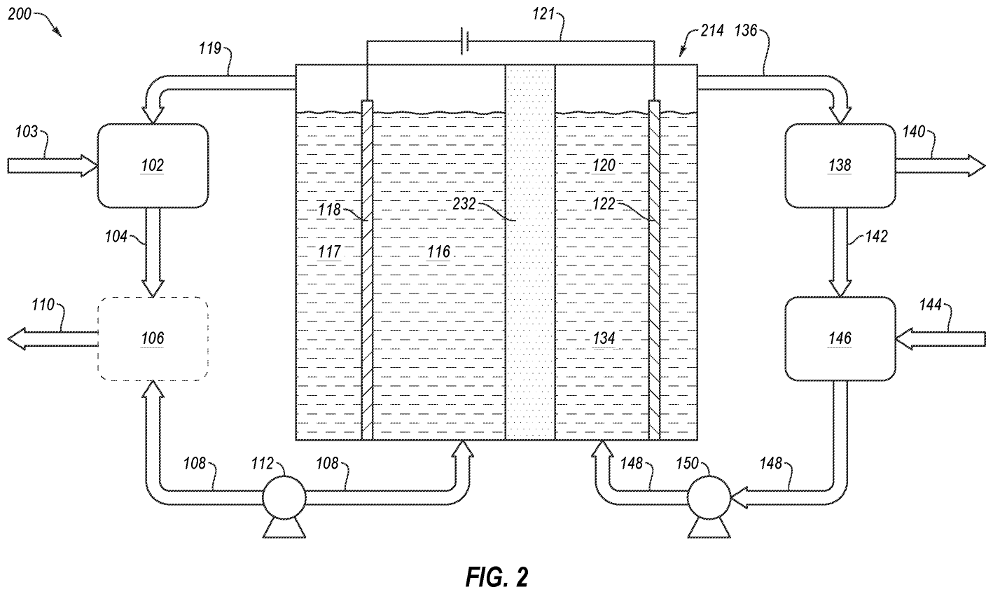

Although the electrochemical cell 114 of FIG. 1 has been described and illustrated as including the center chamber 124 between the anode chamber 116 and the cathode chamber 120, the disclosure is not so limited. In other embodiments, the anode chamber 116 may not be separated from the cathode chamber 120 by a center chamber. FIG. 2 is a simplified schematic of a system 200 for recovering lithium from a lithium-containing material, in accordance with embodiments of the disclosure. The system 200 may be substantially the same as the system 100 of FIG. 1, except that the system 200 includes an electrochemical cell 214 that does not include a center chamber.

The solution 108 may be introduced into the anode chamber 116 of the electrochemical cell 214. In some embodiments, the solution 108 may include one or more metal sulfates, such as one or more of lithium sulfate, manganese sulfate, and another metal sulfate. In some embodiments, the solution 108 may be substantially free of chlorides.

In the anode chamber 116, water within the solution 108 may react to generate hydrogen ions, oxygen gas, and electrons, according to equation (9) below. In some embodiments, such as where the solution 108 includes dissolved manganese, the manganese may be oxidized in the anode chamber 116 to form manganese oxide, according to equation (10) below:

H₂O→2H⁺+½O₂+2e⁻; (9);

Mn²⁺+2H₂O→MnO₂+4H⁺+2e⁻; (10).

With continued reference to FIG. 2, the electrochemical cell 214 may include a cation exchange membrane 232 separating the anode chamber 116 from the cathode chamber 120. The cation exchange membrane 232 may be substantially the same as the second membrane 132 described above with reference to FIG. 1 and may be configured to facilitate selective transport of lithium ions from the anode chamber 116 to the cathode chamber 120.

Accordingly, the system 200 may be configured to facilitate recovery of manganese (in the form of manganese oxide) in the anode chamber 116 concurrently with recovery of lithium (in the form of lithium carbonate) in the cathode chamber 120. Thus, the electrochemical cell 214 may facilitate separation of manganese from lithium.

In some embodiments, the system 200 may be configured to recover lithium from the leachate of lithium-ion batteries. In some such embodiments, the electrochemical cell 214 may not include switchable polarity solvent in the catholyte 134.

In addition, although FIG. 1 and FIG. 2 have been described and illustrated as recovering lithium from a lithium-containing material, in other embodiments, the system 100, 200 may be used for recovery of other materials, such as magnesium or one or more lanthanides (e.g., lanthanum, cerium, praseodymium, neodymium, promethium, samarium, europium, gadolinium, terbium, dysprosium, holmium, erbium, thulium, ytterbium, and lutetium). Such other materials may be present in the lithium-containing material, or the materials may be recovered from materials other than lithium-containing materials. In some such embodiments, the second membrane 132 or the cation exchange membrane 232 may be configured to facilitate transfer of ions of the magnesium or the one or more lanthanides, which may react with bicarbonate ions in the catholyte 134 and form a suitable carbonate compound. The carbonate compound may precipitate from the catholyte 134, facilitating separation of the magnesium and/or one or more lanthanides from the solution 108.

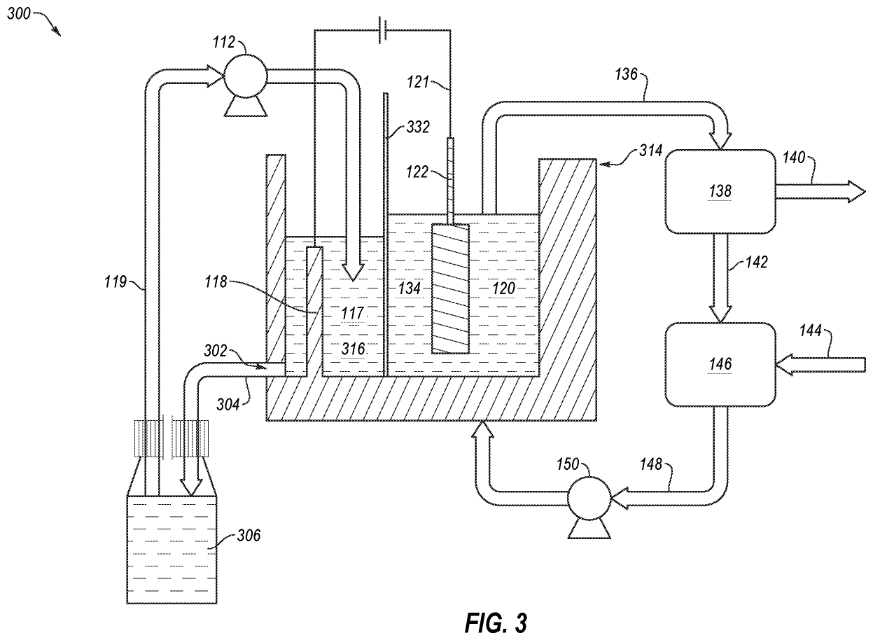

Although FIG. 1 and FIG. 2 have been described as including systems 100, 200 including electrochemical cells 114, 214 having a particular configuration, the disclosure is not so limited. In some embodiments, the system may include an electrochemical cell open to a surrounding atmosphere. FIG. 3 is a simplified schematic of a system 300 for recovering lithium from a lithium-containing material, in accordance with embodiments of the disclosure.

The system 300 may be substantially the same as the system 200 of FIG. 2, except that the system 300 includes an open (e.g., not enclosed) electrochemical cell 314. The electrochemical cell 314 includes a cation exchange membrane 332 between an anode chamber 316 and a cathode chamber 120. The cation exchange membrane 332 may be substantially similar to the cation exchange membrane 232.

The anode chamber 316 may include an opening 302 configured for passing an anolyte 117 from the anode chamber 316 to a vessel 306 through a fluid transfer line 304. A recycle stream 119 of the anolyte 117 may be pumped from the vessel 306 to the anode chamber 316 with pump 112. Accordingly, the anolyte 117 may be cycled from the anode chamber 116 to the vessel 306 and recycled from the vessel 306 to the anode chamber 316. Use of the anode chamber 316 having the opening 302 may facilitate use of the electrochemical cell 314 being open to a surrounding atmosphere.

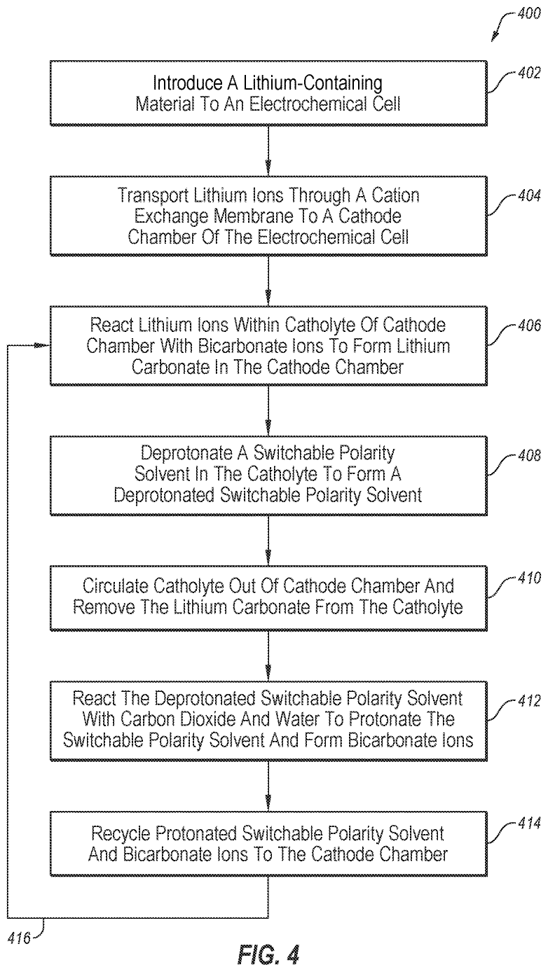

FIG. 4 is a simplified flow diagram illustrating a method 400 of recovering lithium from a lithium-containing solution, in accordance with embodiments of the disclosure. The method 400 includes act 402 introducing a lithium-containing material to an electrochemical cell (e.g., electrochemical cell 114, electrochemical cell 214, electrochemical cell 314); act 404 transporting lithium ions through a cation exchange membrane (e.g., the second membrane 132, the cation exchange membrane 232, the cation exchange membrane 332) to a cathode chamber (e.g., the cathode chamber 120) of the electrochemical cell; act 406 reacting lithium ions within the catholyte (e.g., the catholyte 134) of the cathode chamber with bicarbonate ions to form lithium carbonate in the cathode chamber; act 408 deprotonating a switchable polarity solvent in the catholyte to form a deprotonated switchable polarity solvent; act 410 circulating the catholyte out of the cathode chamber and removing the lithium carbonate from the catholyte; act 412 reacting the deprotonated switchable polarity solvent with carbon dioxide and water to protonate the switchable polarity solvent and form bicarbonate ions; act 414 recycling the protonated switchable polarity solvent and bicarbonate ions to the cathode chamber.

Act 402 includes introducing a lithium-containing material to an electrochemical cell. The lithium-containing material may include a leachate from a leaching process used to remove one or more metals from a lithium-ion battery, a brine, or another material, as described above with reference to FIG. 1 through FIG. 3. The electrochemical cell may be substantially the same as the electrochemical cell 114, the electrochemical cell 214, or the electrochemical cell 314.

Act 404 includes transporting lithium ions through a cation exchange membrane to a cathode chamber of the electrochemical cell. The cation exchange membrane may be substantially the same as the cation exchange membrane described above with reference to FIG. 1 through FIG. 3.

Act 406 includes reacting lithium ions within the catholyte of the cathode chamber with bicarbonate ions to form lithium carbonate in the cathode chamber. For example, the lithium ions may react with bicarbonate ions, as described above with reference to equation (3).

Act 408 includes deprotonating a switchable polarity solvent in the catholyte to form a deprotonated switchable polarity solvent. The switchable polarity solvents may include one or more of the materials described above with reference to FIG. 1 through FIG. 3. In some embodiments, the switchable polarity solvent comprises an amine, such as methyl diethanolamine. Deprotonation of the switchable polarity solvent may change the polarity of the switchable polarity solvent such that the deprotonated switchable polarity solvent is soluble in an organic phase (rather than in an aqueous phase as the protonated switchable polarity solvent). In other embodiments, the deprotonated switchable polarity solvent may remain soluble in the aqueous phase, such as where the switchable polarity solvent comprises methyl diethanolamine. In some such embodiments, the protonated switchable polarity solvent and the deprotonated switchable polarity solvent may be soluble in the aqueous phase.

Act 410 includes circulating the catholyte out of the cathode chamber and removing the lithium carbonate from the catholyte. In some embodiments, the catholyte is circulated through a filter configured to remove the lithium carbonate from the catholyte.

Act 412 includes reacting the deprotonated switchable polarity solvent with carbon dioxide and water to protonate the switchable polarity solvent and form bicarbonate ions. By way of non-limiting example, the switchable polarity solvent may be protonated to change from an organic phase to an aqueous phase, as described above with reference to equation (5). In other embodiments, protonation of the switchable polarity solvent may not change the solubility of the switchable polarity solvent in, for example, the aqueous phase. In addition, reaction of the deprotonated switchable polarity solvent with the carbon dioxide and water may form bicarbonate ions.

Act 414 includes recycling the protonated switchable polarity solvent and bicarbonate ions to the cathode chamber. The bicarbonate ions may react with additional lithium ions in the catholyte of the cathode chamber to form lithium carbonate and the process may be repeated, as indicated at arrow 416.

Accordingly, lithium may be recovered from a lithium-containing material without significant consumption of acids, precipitation agents, or other chemicals. Rather, the switchable polarity solvent may react with carbon dioxide to form bicarbonate ions, which facilitates reaction of lithium ions to form the lithium carbonate precipitate. Since the carbon dioxide is readily available, the method may facilitate recovery of lithium at a reduced cost compared to conventional methods of recovering lithium.

### Example

Lithium was recovered from a lithium-ion battery leachate. The leachate included dissolved lithium and manganese sulfate and was substantially free of cobalt and nickel. The leachate was introduced into an anode chamber of an electrochemical cell including the anode chamber and a cathode chamber, the anode chamber and the cathode chamber separated by a SELEMION™ cation exchange membrane commercially available from AGC Engineering Co., Ltd. of Chiba, Japan. The anode was formed of graphite foil and the cathode was formed of gold plated mesh.

About 24 mL of the leachate were introduced to the anode chamber. The leachate included about 0.2 M lithium sulfate (Li₂SO₄) and about 0.08 M manganese sulfate (MnSO₄). The dissolved lithium was transported to the cathode chamber of the electrochemical cell through the cation exchange membrane. The volume of the cathode chamber was substantially smaller than the volume of the anode chamber to facilitate improved transport of lithium ions from the anode chamber to the cathode chamber. The dissolved manganese remained in the anolyte and was recovered by means of deposition of manganese oxide (MnO₂).

The cathode chamber included a catholyte including methyl diethanolamine and 1 M lithium hydroxide (LiOH). The catholyte was bubbled with carbon dioxide for two days to saturate the methyl diethanolamine with LiHCO₃. Hydrogen gas evolved at the cathode. A voltage of about 5 V was applied between the anode and the cathode for about 20 hours. The lithium from the anode chamber was transferred through the cation exchange membrane and into the catholyte. The lithium reacted with the hydroxide ions and bicarbonate ions in the catholyte to form lithium carbonate according to equation (11) below:

2Li⁺+OH⁻+HCO₃⁻→Li₂CO₃+H₂O; (11).

After about 20 hours, a precipitate that had formed on the cathode was collected. In addition, a precipitate comprising MnO₂ formed on the anode. The precipitate on the cathode included some orange crystals, which may have been MnCO₃. About 79 percent of the lithium initially present in the anode chamber was recovered on the cathode as Li₂CO₃ and about 95 percent of the manganese that was initially present in the anode chamber was recovered on the anode as MnO₂. The lithium carbonate had a purity greater than about 90 percent by weight.

Additional non-limiting example embodiments of the disclosure are set forth below.

Embodiment 1: A method of removing lithium from a lithium-containing material, the method comprising: introducing a lithium-containing material to an electrochemical cell; transporting lithium ions from the lithium-containing material through a cation exchange membrane to a catholyte within a cathode chamber of the electrochemical cell; reacting the lithium ions with bicarbonate ions in the cathode chamber to form lithium carbonate; and removing the lithium carbonate from the catholyte.

Embodiment 2: The method of Embodiment 1, wherein introducing a lithium-containing material to an electrochemical cell comprises introducing a leachate from a leaching process for leaching one or more metals from a lithium-ion battery to the electrochemical cell.

Embodiment 3: The method of Embodiment 2, further comprising removing one or more of nickel, cobalt, and manganese from the leachate prior to introducing the lithium-containing material to the electrochemical cell.

Embodiment 4: The method of any one of Embodiments 1 through 3, wherein transporting lithium ions from the lithium-containing material through a cation exchange membrane comprises transporting the lithium ions from the lithium-containing material through a monovalent cation exchange membrane.

Embodiment 5: The method of any one of Embodiments 1 through 4, further comprising deprotonating a switchable polarity solvent in the cathode chamber to form water.

Embodiment 6: The method of any one of Embodiments 1 through 5, further comprising reacting a deprotonated switchable polarity solvent with carbon dioxide and water to form the bicarbonate ions and a protonated switchable polarity solvent external to the cathode chamber.

Embodiment 7: The method of any one of Embodiments 1 through 6, further comprising introducing the bicarbonate ions and the protonated switchable polarity solvent to the catholyte.

Embodiment 8: The method of any one of Embodiments 1 through 7, further comprising introducing a switchable polarity solvent comprising a tertiary amine to the cathode chamber.

Embodiment 9: The method of any one of Embodiments 1 through 8, further comprising oxidizing manganese ions in an anode chamber of the electrochemical cell.

Embodiment 10: The method of any one of Embodiments 1 through 9, wherein removing the lithium carbonate from the catholyte comprises passing the catholyte through a filter to remove the lithium carbonate from the catholyte.

Embodiment 11: A method of recovering lithium from a lithium-containing material, the method comprising: providing a catholyte comprising a protonated switchable polarity solvent in a cathode chamber of an electrochemical cell; transporting lithium ions from a lithium-containing material through a cation exchange membrane into the cathode chamber; reacting the lithium ions with bicarbonate ions to form lithium carbonate in the cathode chamber; reacting the protonated switchable polarity solvent with hydroxide ions to form a deprotonated switchable polarity solvent and water; and contacting the deprotonated switchable polarity solvent with carbon dioxide and water to protonate the deprotonated switchable polarity solvent and produce bicarbonate ions.

Embodiment 12: The method of Embodiment 11, wherein providing a catholyte comprising a protonated switchable polarity solvent in a cathode chamber of an electrochemical cell comprises providing the protonated switchable polarity solvent contacted by the carbon dioxide to the cathode chamber.

Embodiment 13: The method of Embodiment 11 or Embodiment 12, wherein providing a catholyte comprising a protonated switchable polarity solvent in a cathode chamber comprises providing the protonated switchable polarity solvent to a cathode chamber comprising one or more of platinum, nickel, gold, iridium oxide, titanium, and carbon to the cathode chamber.

Embodiment 14: The method of any one of Embodiments 11 through 13, further comprising providing the bicarbonate ions to the cathode chamber.

Embodiment 15: The method of any one of Embodiments 11 through 14, further comprising reacting hydroxide ions at an anode of the electrochemical cell to form oxygen and water.

Embodiment 16: The method of any one of Embodiments 11 through 15, wherein providing a catholyte comprising a protonated switchable polarity solvent in a cathode chamber of an electrochemical cell comprises providing a catholyte comprising a tertiary amine to the cathode chamber.

Embodiment 17: The method of any one of Embodiments 11 through 15, wherein providing a catholyte comprising a protonated switchable polarity solvent in a cathode chamber of an electrochemical cell comprises providing a catholyte comprising one or more of methyl diethanolamine, diethanolamine, and monoethanolamine to the cathode chamber.

Embodiment 18: A system for recovering lithium from a lithium-containing leachate, the system comprising: an electrochemical cell comprising an anode chamber and a cathode chamber, the cathode chamber configured to receive a catholyte comprising a switchable polarity solvent and bicarbonate ions; and a monovalent cation exchange membrane separating the anode chamber from the cathode chamber.

Embodiment 19: The system of Embodiment 18, wherein the switchable polarity solvent is protonated within the catholyte.

Embodiment 20: The system of Embodiment 18 or Embodiment 19, further comprising a carbon dioxide source configured to protonate the switchable polarity solvent from a deprotonated state to a protonated state.

Embodiment 21: The system of any one of Embodiments 18 through 20, further comprising: a center chamber in the electrochemical cell between the anode chamber and the cathode chamber; and a bipolar membrane between the center chamber and the anode chamber.

Embodiment 22: The system of any one of Embodiments 18 through 21, wherein the catholyte comprises an aqueous phase and an organic phase.

Embodiment 23: The system of Embodiment 22, wherein the organic phase comprises an alcohol.

While embodiments of the disclosure may be susceptible to various modifications and alternative forms, specific embodiments have been shown by way of example in the drawings and have been described in detail herein. However, it should be understood that the disclosure is not limited to the particular forms disclosed. Rather, the disclosure encompasses all modifications, variations, combinations, and alternatives falling within the scope of the disclosure as defined by the following appended claims and their legal equivalents.

1. A method of removing lithium from a lithium-containing material, the method comprising:
introducing a lithium-containing material to an electrochemical cell;
transporting lithium ions from the lithium-containing material through a cation exchange membrane to a catholyte within a cathode chamber of the electrochemical cell;
reacting the lithium ions with bicarbonate ions in the cathode chamber to form lithium carbonate; and
removing the lithium carbonate from the catholyte.

2. The method of claim 1, wherein introducing a lithium-containing material to an electrochemical cell comprises introducing a leachate from a leaching process for leaching one or more metals from a lithium-ion battery to the electrochemical cell.

3. The method of claim 2, further comprising removing one or more of nickel, cobalt, and manganese from the leachate prior to introducing the lithium-containing material to the electrochemical cell.

4. The method of claim 1, wherein transporting lithium ions from the lithium-containing material through a cation exchange membrane comprises transporting the lithium ions from the lithium-containing material through a monovalent cation exchange membrane.

5. The method of claim 1, further comprising deprotonating a switchable polarity solvent in the cathode chamber to form water.

6. The method of claim 1, further comprising reacting a deprotonated switchable polarity solvent with carbon dioxide and water to form the bicarbonate ions and a protonated switchable polarity solvent external to the cathode chamber.

7. The method of claim 6, further comprising introducing the bicarbonate ions and the protonated switchable polarity solvent to the catholyte.

8. The method of claim 1, further comprising introducing a switchable polarity solvent comprising a tertiary amine to the cathode chamber.

9. The method of claim 1, further comprising oxidizing manganese ions in an anode chamber of the electrochemical cell.

10. The method of claim 1, wherein removing the lithium carbonate from the catholyte comprises passing the catholyte through a filter to remove the lithium carbonate from the catholyte.

11. A method of recovering lithium from a lithium-containing material, the method comprising:
providing a catholyte comprising a protonated switchable polarity solvent in a cathode chamber of an electrochemical cell;
transporting lithium ions from a lithium-containing material through a cation exchange membrane into the cathode chamber;
reacting the lithium ions with bicarbonate ions to form lithium carbonate in the cathode chamber;
reacting the protonated switchable polarity solvent with hydroxide ions to form a deprotonated switchable polarity solvent and water; and
contacting the deprotonated switchable polarity solvent with carbon dioxide and water to protonate the deprotonated switchable polarity solvent and produce bicarbonate ions.

12. The method of claim 11, wherein providing a catholyte comprising a protonated switchable polarity solvent in a cathode chamber of an electrochemical cell comprises providing the protonated switchable polarity solvent contacted by the carbon dioxide to the cathode chamber.

13. The method of claim 11, wherein providing a catholyte comprising a protonated switchable polarity solvent in a cathode chamber comprises providing the protonated switchable polarity solvent to a cathode chamber comprising one or more of platinum, nickel, gold, iridium oxide, titanium, and carbon to the cathode chamber.

14. The method of claim 11, further comprising providing the bicarbonate ions to the cathode chamber.

15. The method of claim 11, further comprising reacting hydroxide ions at an anode of the electrochemical cell to form oxygen and water.

16. The method of claim 11, wherein providing a catholyte comprising a protonated switchable polarity solvent in a cathode chamber of an electrochemical cell comprises providing a catholyte comprising a tertiary amine to the cathode chamber.

17. The method of claim 11, wherein providing a catholyte comprising a protonated switchable polarity solvent in a cathode chamber of an electrochemical cell comprises providing a catholyte comprising one or more of methyl diethanolamine, diethanolamine, and monoethanolamine to the cathode chamber.

18. A system for recovering lithium from a lithium-containing, leachate, the system comprising:
an electrochemical cell comprising an anode chamber and a cathode chamber, the cathode chamber configured to receive a catholyte comprising a switchable polarity solvent and bicarbonate ions; and
a monovalent cation exchange membrane separating the anode chamber from the cathode chamber.

19. The system of claim 18, wherein the switchable polarity solvent is formulated to be protonated within the catholyte.

20. The system of claim 18, further comprising a carbon dioxide source configured to protonate the switchable polarity solvent from a deprotonated state to a protonated state.

21. The system of claim 18, further comprising:
a center chamber in the electrochemical cell between the anode chamber and the cathode chamber; and
a bipolar membrane between the center chamber and the anode chamber.

22. The system of claim 18, wherein the catholyte comprises an aqueous phase and an organic phase.

23. The system of claim 22, wherein the organic phase comprises an alcohol.
